(19) United States
(12) Patent Application Publication
(10) Pub. No.: US 2010/0233060 A1
(43) Pub. Date: Sep. 16, 2010

(54) METHOD FOR THE PRODUCTION OF A NANO-SCALE SILICON DIOXIDE

(75) Inventors: Uwe Dietrich Kühner, Hamburg (DE); Robert Wieczorreck, Barsbuttel (DE); Onno Graalmann, Geesthacht (DE); Christof Roscher, Essen (DE)

Correspondence Address: Casimir Jones, S.C., 2275 DEMING WAY, SUITE 310, MIDDLETON, WI, 53562, US

(73) Assignee: NANORESINS AG, Geesthacht (DE)

(21) Appl. No.: 12/671,194

(22) PCT Filed: Jun. 10, 2008
(86) PCT No.: PCT/EP08/04634

§ 371 Date: Jan. 28, 2010

(30) Foreign Application Priority Data
Jul. 30, 2007 (EP) 07014926.5

(51) Int. Cl. C01B 33/12

(52) U.S. Cl. 423/335; 977/700; 977/773

(57) ABSTRACT

The object of the invention is a method for the production of a nano-scale silicon dioxide, said method comprising the following steps: a) provision of an aqueous suspension of a colloidal silicon dioxide with an average particle size of 1 to 500 nm; b) allowing said suspension to react with an organosilane or organosiloxane in an aprotic cyclic ether and silanization of the colloidal silicon dioxide; c) separation of the aqueous phase of the reaction mixture from the organic phase; d) allowing the organic phase to react again with an organosilane or organosiloxane in an aprotic cyclic ether and silanization of the colloidal silicon dioxide; e) separation of the aqueous phase of the reaction mixture from the organic phase.

The invention relates to a method of producing a nanoscale silicon dioxide.

The addition to polymeric materials such as, for example, polyurethanes, polyureas or what are called reactive resins, of fillers, for the purpose of modifying certain properties of the polymeric material, is known. For example, it is possible in this way to improve impact strength, flexural strength, hardness or electrical insulation capacity.

The use of silica or silicon dioxide (SiO₂) as a filler in polymers is already known. Various methods of producing SiO₂ fillers are known from public prior use.

Natural (mineral) SiO₂ can be brought to a desired particle size by grinding, for example, and can be mixed with the polymer or with a polymer precursor. Ground SiO₂ generally has a very broad particle size distribution and irregular particle structure. Particle sizes of below 1 μm are difficult, if not impossible, to obtain by mechanical comminution of the SiO₂.

Also known is the precipitation of SiO₂ from aqueous alkali metal silicate solutions by acidification, and its subsequent drying. This precipitated SiO₂ is mixed with the polymer or with a precursor. Here again, irregular particle structures with very broad particle size distributions are obtained.

A further possibility is the production of fumed silica by flame hydrolysis of silicon halogen compounds. This produces particles with a very complex morphology and an extremely broad particle size distribution, since some of the primary particles formed in the flame hydrolysis undergo agglomeration and form other associated superstructures. Fumed silica, moreover, is expensive to produce.

The hydrolysis and condensation of organofunctional silanes (especially alkoxy silanes) to produce aqueous or aqueous-alcoholic silica sols, and the mixing of these sols with a polymer precursor, are also known. Subsequently it is possible to remove water and/or alcohol from the mixture. This method is expensive and on an industrial scale is difficult to control.

The methods described have the disadvantage, furthermore, that it is not possible to produce, specifically, SiO₂ fillers having a monomodal, narrow particle size distribution; this disadvantage is particularly pronounced for the three first-mentioned methods. As a result of this, dispersions of the filler in polymer precursors, even at relatively low filler concentrations, exhibit unwanted rheological properties, more particularly a high viscosity, which make processing more difficult.

EP A 0 982 268 discloses a method of producing colloidal silica that involves silanizing an aqueous suspension of a colloidal SiO₂.

The invention is based on the object of providing a method of the type specified at the outset that provides a hydrophobic, monodisperse, nanoscale silicon dioxide that can be put to diverse use.

The method of the invention comprises the following steps:
a) providing an aqueous suspension of a colloidal silicon dioxide having an average particle size of 1 to 500 nm;
b) reacting it with an organosilane or organosiloxane in an aprotic cyclic ether, and silanizing the colloidal silicon dioxide;
c) separating the aqueous phase of the reaction mixture from the organic phase;
d) again reacting the organic phase with an organosilane or organosiloxane in an aprotic cyclic ether, and silanizing the colloidal silicon dioxide;
e) separating the aqueous phase of the reaction mixture from the organic phase.

The method of the invention starts from a nanoscale, colloidal silica sol. The pH of this sol is set preferably at 5 or less, more preferably at 4 or less. In the case of a basic sol, this can be done by adding acid or by using an acidic cation exchanger.

In the next step, an organosilane or organosiloxane in an aprotic cyclic ether (e.g., dioxane, more preferably THF) is added, and the system is mixed with stirring. A silanization takes place, in the course of which stirring is carried out, preferably intensively. After about an hour, the reaction is over, and phase separation has taken place. The organic phase comprises the solvent (THF), the silanized colloidal SiO₂, and small amounts of water. The aqueous phase is separated off and discarded. The term “aqueous phase”, in the context of the invention, identifies the phase with the more polar solvent. It preferably comprises substantially water, but may also comprise water-miscible or water-soluble (preferably polar) organic solvents. The term “organic phase” identifies the less polar phase.

In a subsequent step, silanization is carried out a second time by further addition of an organosilane or organosiloxane. The reaction is again carried out until two phases are formed. The upper phase contains the greatest fraction of the residual water, the bottom phase the silanized colloidal SiO₂.

The colloidal SiO₂ used in step a) preferably has an average particle size of 2 to 300 nm, more preferably 3 to 200 nm, more preferably 4 to 150 nm, more preferably 4 to 80 nm, more preferably 10 to 40 nm.

The nanoscale silicon dioxide produced in accordance with the invention is preferably hydrophobic or hydrophobicized as a result of the silanization of the surface. It can therefore be incorporated particularly effectively into an apolar and hence hydrophobic matrix such as, for example, a polymer matrix.

The nanoscale silicon dioxide of the invention is composed preferably to an extent of at least 50% of separate, unaggregated and unagglomerated primary particles. This separation is preferably retained when the particles, either from the solvent or else after removal of the solvent, in the form of a redispersible powder, are incorporated into a polymer matrix. Other preferred lower limits are 70%, 80%, 90%, 95%, and 98%. These percentages are % by weight. According to this aspect of the invention, then, it is possible to provide a dispersion or a redispersible powder that is substantially free from aggregates and/or agglomerates of the silicon dioxide particles. This improves the processing properties (lower viscosity) and the mechanical properties of intermediates and end products that are produced using the silicon dioxide particles produced in accordance with the invention.

The organosilanes or organosiloxanes are preferably selected from the group consisting of organosilanes of the formula R¹ₐH_{b}SiX_{4-a-b} and organosiloxanes of the formula R¹ₙSiO_{(4-n)/2}, in which each R¹ independently is selected from hydrocarbon radicals having 1 to 18 carbon atoms or organofunctional hydrocarbon radicals having 1 to 18 carbon atoms, each X is selected independently from a halogen atom or alkoxy radicals having 1 to 18 carbon atoms, a=0, 1, 2 or 3, b=0 or 1, a+b=1, 2 or 3, with the proviso that if b=1, then a+b=2 or 3 and n is an integer from 2 up to and including 3.

Particular preference is given to using a halosilane, more preferably a chlorosilane. The silanes may be functionalized, as for example with polymerizable groups, more particularly vinyl groups. In the context of the invention it is possible to carry out the two silanization steps with different silanes. For example, a functionalized silane, preferably a vinyl silane, can be used only in one of the two silanization steps. It is likewise possible to use mixtures of functionalized and nonfunctionalized silanes in one silanization step.

In the context of the invention it is preferred, when using functionalized silanes, for them to be used entirely or predominantly in the second silanization step. It has been found that in that case the functionalization of the particle surface that is achieved is greater.

The silanization in steps b) and d) of claim 1 is carried out preferably at 0 to 65° C., more preferably 10 to 65° C. The first silanization step, in one variant of the invention, can be carried out at lower temperatures (preferably 0 to 20° C., more preferably 0 to 10° C.) and the second step, which can be carried out, for example, at 20 to 65° C.

In the context of the invention it is possible to carry out a silanization additionally before the first silanization step (step b) of claim 1) is carried out, by adding an alkoxy silane to the aqueous suspension itself.

After the second silanization has been carried out, it is preferred to replace the cyclic ether by another aprotic organic solvent, preferably toluene. For this purpose, the cyclic ether may be removed by distillation. This is done preferably with addition of the second solvent (e.g., xylene, butyl acetate, methyl isobutyl ketone, or toluene) as an azeotrope former. It is preferred, following the removal of the cyclic ether, to carry out further heating under reflux, in which case, preferably, the refluxing solvent is neutralized with a base. For the neutralization it is possible to use a basic salt such as, for example, an alkali metal or alkaline earth metal carbonate or hydrogen carbonate. The solvent may be passed, for example, through a column filled with the basic salt.

In accordance with the invention it is possible to prepare solvent-free powders from the suspension. For this purpose, the solvent is removed at elevated temperature under reduced pressure. The resulting powder, by means of simple stirring, can be redispersed monodispersely in a multiplicity of solvents, monomers, and polymers. The particle size remains constant; agglomeration or aggregation takes place not at all or at most to an insubstantial extent.

The dispersion produced in accordance with the invention, or the redispersible powder obtained from the dispersion by removal of the solvent, can be incorporated into a very wide variety of base polymers and can improve or modify their physical, and more particularly mechanical, properties. Base polymers which can be used in the context of the invention include a multiplicity of known polymers. For example, thermoplastic of thermoset plastics can be modified by means of silicon dioxide particles produced in accordance with the invention. Examples include polyolefins, polycarbonates, polyamides, polyimides, polyacrylates, polymethacrylates, polyetherketones, polysulfones, polyurethanes, polyureas, epoxy resins, polyester resins, and polysiloxanes (silicones). Examples of elastomers which can be modified include natural rubber, butyl rubbers, acrylate rubbers, styrene-butadiene rubber (SBR), unhydrogenated or hydrogenated nitrile-butadiene rubbers, etc. For many of these groups of materials it is particularly advantageous to incorporate the nanoparticles produced in accordance with the invention in the form of a redispersible powder, since their introduction via solvent is disadvantageous and is associated with high expense and complexity.

With particular advantage the nanoscale silicon dioxide produced in accordance with the invention can also be incorporated into polymers or resins having a low boiling point, such as, for example, methyl methacrylate (MMA).

Nanoscale particles produced in accordance with the invention may likewise be used for modifying plasticizers such as, for example, adipates and phthalates. With these plasticizers they form stable dispersions of low viscosity.

Polymeric or polymerizable mixtures modified with the particles produced in accordance with the invention are stable and storable dispersions and have good flow properties (low viscosity, low structural viscosity). They are therefore suitable, for example, for producing dental formulations which are applied, for example, from a static mixer and hence must not have too high a processing viscosity. With particular preference they can be used with dental formulations based on silicones.

Another possible field of application is the modification of LSRs (Liquid Silicone Rubbers), which are processed generally by injection molding and in which, therefore, a low processing viscosity is of great advantage. In accordance with the invention, in LSRs, a high filler content and hence good mechanical properties of the cured end product can be achieved, without the processing properties suffering from too high a viscosity.

In principle the invention makes it possible to provide polymerizable mixtures which on account of their low viscosity have good processing properties and, as a cured polymer, have improved properties brought about by means of a high filler content, more particularly mechanical properties, improved thermal conductivity, and the like.

According to one embodiment of the invention, the silane or siloxane used in the second silanization step has free SiH groups, and so, after this second silanization step, there are free SiH groups on the surface of the silicon dioxide particles. SiH groups are very sensitive to hydrolysis. In the context of the invention, the first silanization step already makes the surface of the SiO₂ particles largely water-free, and so in the second silanization step it is possible to apply SiH groups to the surface that are sufficiently stable and are not immediately hydrolyzed by residual moisture.

In accordance with another variant of the invention, this SiH group is then available for hydrosilylation. By means of this hydrosilylation, the surface of the silicon dioxide particles can be provided with specific organic modification, as for example by hydrosilylation with an alkene or an alkyl compound. The invention accordingly also provides nanoscale silicon dioxide particles which have free SiH groups on the surface (process product of claim 20). They permit, so to speak, a building-block chemistry for specific attachment of desired molecules by means of hydrosilylation.

Working examples of the invention are described below. In the drawings,

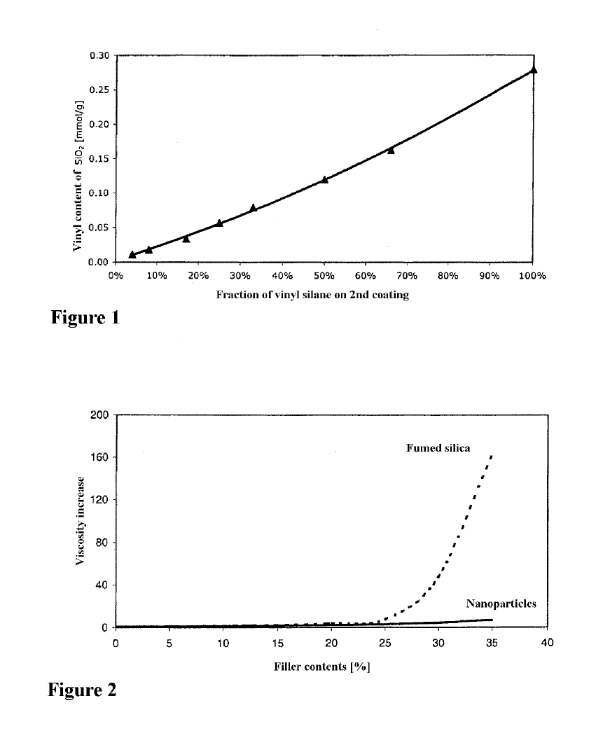

FIG. 1 shows, in a graph, the degree of functionalization of the SiO₂ surface as a function of the amount of vinyl silane used in the second silanization step;

FIG. 2 shows the increase in viscosity of a resin modified with a nanoscale silicon dioxide of the invention, in comparison to a resin modified with fumed silica.

In the examples below, plastics composites are produced using the nanoparticles of the invention, and their properties are ascertained. This is done using the measurement techniques that are described below.

### 1.1 Viscosity

The viscosity of the nanofilled resins was measured at 25° C. on a Brookfield RVDV-II+viscometer using spindle 42.

### 1.2 Mechanical Properties

The tensile properties (elongation at break, tensile strength, elasticity modulus (at 100% elongation)) were determined on the basis of test specimens in analogy to DIN 53504/ISO 37 (form die S2) on a tensile testing machine from Zwick. The Shore hardness was determined in accordance with DIN 53505.

### 1.3 Particle Size

The particle size was determined at 10% solids content in toluenic dispersion by dynamic light scattering on a Horiba LB-550 dynamic light scattering particle size analyzer. The particle size reported is the D50 value of the particle size distribution. One measure of the breadth of the distribution is the span. This is dimensionless and is calculated from (D90-D10)/D50.

### 1.4 Determination of the Vinyl Groups

The volatile constituents of the dispersion under analysis are removed at 80° C. under reduced pressure. The measurement is carried out on the resulting powder.
The sample under analysis is weighed out on an analytical balance into a 250 ml Erlenmeyer flask, and the initial mass is recorded to an accuracy of 0.0001 g. 75 ml of toluene are added, and the sample is dissolved with stirring. Then 20.0 ml of Wijs solution are pipetted in. The flask is sealed and left to stand in the dark for at least 60 minutes.
After the time has expired, 16 ml of 10% strength KI solution and 60 ml of distilled water are added, in that order. The two-phase, brownish red mixture is titrated with 0.1 molar sodium thiosulfate solution. During this titration, the system must be stirred intensively so that the two phases are well mixed. Sodium thiosulfate solution is added until the aqueous phase is bright orange to yellow. Then about 1 ml of 1% strength starch solution is added, producing an intense blue to black coloration. Titration is continued until there is a color change to milky white. Following the color change, stirring is continued for about 2 minutes more, in order to ensure that the red coloration does not reoccur. The amount consumed is recorded. If less than 37 ml of sodium thiosulfate solution are consumed in the blank test, the entire test must be repeated. It is also necessary to calculate the halogen excess. If the value is less than 120%, the test must be repeated with a smaller initial mass.
Calculation of the vinyl content:

$$Vinyl content V = \frac{( b - a ) * 0.05}{E}$$

V: vinyl content in mmol/g
a: consumption of 0.1 M Na₂S₂O₃ solution in ml in test
b: consumption of 0.1 M Na₂S₂O₃ solution in ml for blank value
E: initial mass of solid in g
Calculation of the halogen excess:

$$Halogen excess X = \frac{a * 100}{( b - a )}$$

X: halogen excess
a: consumption of 0.1 M Na₂S₂O₃ solution in ml in test
b: consumption of 0.1 M Na₂S₂O₃ solution in ml for blank value

### 1.5 Determination of the SiH Groups by Gas Volumetry

The volatile constituents of the dispersion under analysis are removed at 80° C. under reduced pressure. The measurement is carried out on the resulting powder.
Duplicate determinations without a blank test are carried out.
The initial mass is to be calculated in accordance with the following formula:

$$E = \frac{1.5}{{c}_{SiH}}$$

E: initial mass of solid in g
c_{SiH}: expected SiH content
The calculated amount is weighed out on an analytical balance into a two-neck flask, and the initial mass is recorded to an accuracy of 0.0001 g. 20 ml of butanol are added with the aid of a measuring cylinder and a magnetic stirrer bar.
A dropping funnel attached with collar and clamp and with pressure compensation is filled with 15 ml of potassium tert-butoxide solution in butanol. So that the sealing is gas tight, all of the joints are greased. An opened joint tap is mounted on the dropping funnel. A two-neck flask is connected to the dropping funnel and to the gas burette, which must be filled with water and connected to a compensation flask which is mounted height-adjustably next to the burette. The connections between dropping funnel and joint tap, dropping funnel and two-neck flask, and two-neck flask and burette are secured with joint clamps. The apparatus is oriented vertically and the stirrer is started. The burette is raised to a height such that the water level is exactly at zero. The apparatus is then sealed. The water level is checked again and corrected if necessary. For pressure compensation, the top tap must be opened again.
Opening the tap on the dropping funnel causes the potassium tert-butoxide solution to run into the two-neck flask. Evolution of gas then begins in the flask, and the hydrogen gas produced presses the water level in the burette downward. During the evolution of gas, the compensation vessel should be moved on the rod of the stand, in accordance with the downwardly moving level, so that no overpressure is produced in the apparatus. Around every 5 minutes, the change in the water level, in the temperature and in the air pressure are recorded as intermediate values. For precise reading, the level of the compensation vessel must be brought to the same height as that of the burette. When there is no longer any measurable change, the system is left for 5 minutes and then the three parameters are recorded, as final measurements.

Evaluation:

$${c}_{SiH} = \frac{V * 273.15 * p}{22.41 * ( T + 273.15 ) * 1000 * E}$$

c_{SiH}: SiH content in mmol/g
V: volume of gas produced, in ml
p: air pressure in mbar
T: laboratory temperature in ° C.
E: initial mass in g

Starting Materials Used
The method of the invention uses an aqueous suspension of a colloidal silicon dioxide. Known preparation methods are suitable for preparing this suspension.
For example, particles obtained from the hydrolysis of alkoxy silanes can be used in the method. Particularly suitable are particles of the kind formed in the condensation of acidified water glass. The methods for this are adequately described in the literature. There is a range of products available on the commercial market, such as, for example, Bindzil 40/130 and Bindzil 40/220 (Eka Chemicals) or Levasil 200/40% (H.C.Starck).
Silica sols with particle sizes of less than 100 nm frequently have basic stabilization. Generally speaking, the stabilizer is ammonia or sodium hydroxide solution. If necessary, these stabilizers can be removed using, for example, an ion exchanger.

### EXAMPLE 1

### Preparation of a Silicon Dioxide Dispersion in Toluene

A three-neck flask was charged with 63 g of chlorotrimethylsilane in 1260 g of THF, and, with thorough stirring, 1050 g of silica sol (Levasil 200/40%, BET=200 m²/g, 40% SiO₂, Na⁺ removed with ion exchanger) were added dropwise via a dropping funnel.
Within an hour, two phases had formed, and were separated in a separating funnel. The bottom phase contained more than 99% of the solid, while the top phase contained a major fraction of the water. The bottom phase was diluted with 140 g of THF, and, with stirring, 63 g of chlorotrimethylsilane were added. After an hour of stirring, the material was transferred to a separating funnel.
Over the course of an hour, again, two phases had formed, which were left to separate. The top phase was composed primarily of water and THF.
The bottom phase was transferred to a three-neck flask and diluted with 400 g of toluene. Then, with addition of further toluene, a mixture of THF, water, and toluene was removed by distillation. The toluene was added in such a way that the solution did not dry out. Distillation was carried out until the boiling temperature was close to that of toluene.

The resulting toluene sol, which was still acidic, was heated under reflux, and the distillate flowing back was passed through a column filled with sodium carbonate. After 6 hours of reflux, the sol no longer gave an acidic reaction.

### EXAMPLE 2

### Preparing a Silicon Dioxide Suspension in THF

Preparation takes place as in example 1, but the replacement of the THF by toluene, with removal of THF, is omitted. This gives a sol having a solids content of between 45% and 55% by weight. For neutralization, the THF sol is heated under reflux for 6 hours, and the refluxing solvent is passed via a basic ion exchanger (Amberjet 4400 OH from Rohm & Haas).

### EXAMPLE 3

### Preparation of a Vinyl-Functionalized Silicon Dioxide Dispersion in Toluene

Preparation takes place as described in example 1. In the first and/or second silanization step, however, chlorotrimethylsilane (TMSCl) is replaced wholly or partly by chlorodimethylvinylsilane (DMVSCl).

A total of nine experiments are carried out with different proportions of the two silanes in the first and second silanization; details are given in table 1.

TABLE 1

Fraction of DMVSCl as a proportion
of the amount of silane

| | 1st | 2nd | Vinyl content |
|---|---|---|---|
| No. | silanization | silanization | [mmol/g] |
| 3.1 | 100% | 0% | 0.178 |
| 3.2 | 0% | 100% | 0.279 |
| 3.3 | 0% | 66% | 0.162 |
| 3.4 | 0% | 50% | 0.120 |
| 3.5 | 0% | 33% | 0.079 |
| 3.6 | 0% | 25% | 0.057 |
| 3.7 | 0% | 17% | 0.034 |
| 3.8 | 0% | 8% | 0.018 |
| 3.9 | 0% | 4% | 0.011 |

From the table it can be seen that the use of chlorodimethylvinylsilane in the second silanization leads to a higher vinyl functionalization of the surface than does the use of the same amount of chlorotrimethylvinylsilane in the first silanization (examples 3.1 and 3.2).
In FIG. 1, in a graph, the degree of functionalization of the SiO₂ surface is plotted as a function of the amount of chlorodimethylvinylsilane used in the second silanization step.

### EXAMPLE 4

The nanoscale silicon dioxide dispersions are used to produce nanofilled resins. The base polymer used for the resin comprises vinyl-terminated polydimethylsiloxanes (Polymer VS, hanse chemie AG).
To introduce the nanoparticles into the base polymer (production of the nanocomposite), one part by weight of the base polymer is diluted with one part by weight of toluene. The dispersion of the nanoscale silicon dioxide particles in the solvent is added to the polymer with thorough stirring. The material is then heated to 90° C. and solvents are removed under reduced pressure.
The nanoscale silicon dioxide dispersion of example 3.4 was incorporated into four different Polymer VS variants with different base viscosities. Composites were produced composed of 30% by weight of the nanoparticles and 70% by weight of the base polymer (vinyl-terminated polydimethylsiloxane).
Table 2 shows the viscosities of the base polymers and the viscosity measured following incorporation of the nanoparticles.

TABLE 2

| Viscosity of the | Viscosity of the | Viscosity |
|---|---|---|
| polymer [Pas] | nanocomposite [Pas] | increase (factor) |
| 1 | 4.3 | 4.3 |
| 2 | 7 | 3.5 |
| 10 | 30 | 3.0 |
| 61 | 171 | 2.8 |

The table shows that, even with a degree of filling of 30%, there is only a relatively small viscosity increase on the part of the polymers, which thus remain readily processable.
For comparison with conventional fillers, Polymer VS 2000 (viscosity 2 Pas, hanse chemie AG) was mixed both with nanoparticles (example 3.4) and with Aerosil R8200 (hydrophobicized, low-viscosity, fumed silica, Degussa AG). In this case a much greater increase in viscosity is found when using the fumed silica than in the case of the nanoparticles (FIG. 2). At a 30% filler fraction, the composite based on Aerosil R8200 has a 47 times higher viscosity than the base polymer. In contrast, the viscosity of the nanocomposite is only 3.5 times higher than that of the base polymer.

### EXAMPLE 5

### Addition-Crosslinking Polysiloxanes (Silicone Rubbers) are Produced with the Nanoparticles of the Invention

The base polymer used is a vinyl-terminated polydimethylsiloxane having a viscosity of 65 Pas (Polymer VS 65 000 from hanse chemie AG). Further ingredients of the formula are Polymer VS1000 (vinyl-terminated polydimethylsiloxane having a viscosity of 1 Pas), Catalyst 520 (platinum catalyst, 2% platinum in methylvinylcyclosiloxane), and MVC (methylvinylcyclosiloxane), all from hanse chemie AG. Vulcanization took place in a two-component system by means of platinum-catalyzed hydrosilylation. In this reaction, a polydimethylsiloxane having SiH groups (Crosslinker 210, SiH content about 4.35 mmol/g, hanse chemie AG) reacts with the vinyl groups of the Polymer VS.
The ingredients of the A component were weighed out into a Hauschild DAC 150 FV speed mixer in accordance with table 3, and mixed until they were homogeneous. Then A component and B component were mixed in a mass ratio of 100:4.54, and the mixture was devolatalized under reduced pressure. After being coated out with a 2 mm doctor blade, the specimens were vulcanized at 80° C. for one hour.

TABLE 3

| | |
|---|---|
| A component | B component |

| | Mass | | Mass |
|---|---|---|---|
| | fraction | | fraction |
| Polymer VS 1000 | 19.8% | Crosslinker | 100% |
| Polymer VS 65 000 with | 80.0% | 210 | |
| 30% by weight of | | | |
| nanoparticles from | | | |
| examples 3.2 to 3.9 | | | |
| Catalyst 520 | 0.15% | | |
| MVC | 0.05% | | |

As is evident from table 3, the experiments use a base polymer VS 65 000 to which 30% by weight of nanoparticles from examples 3.2 to 3.9 have been added. Production takes place as specified in example 4.
After cooling had taken place, the mechanical properties of the resulting specimens were ascertained. These properties are summarized in table 4.

TABLE 4

| | Vinyl content | | | | |
|---|---|---|---|---|---|
| Particles | of the | Tensile | | Elasticity | |
| from | nanoparticles | strength | Elongation | modulus | Shore |
| example | [mmol/g] | [MPa] | [%] | [MPa] | A |
| 3.2 | 0.279 | 2.75 | 230 | 1.06 | 41.0 |
| 3.3 | 0.162 | 2.52 | 236 | 0.99 | 39.5 |
| 3.4 | 0.120 | 2.80 | 265 | 1.00 | 37.0 |
| 3.5 | 0.075 | 2.58 | 281 | 0.85 | 34.0 |
| 3.6 | 0.057 | 2.34 | 270 | 0.79 | 30.5 |
| 3.7 | 0.034 | 2.29 | 305 | 0.65 | 30.5 |
| 3.8 | 0.018 | 1.91 | 316 | 0.45 | 25.5 |
| 3.9 | 0.011 | 1.78 | 334 | 0.32 | 24.0 |

It can be seen from table 4 that the vinyl groups on the surface of the particles evidently react with the crosslinker and provide for attachment of the filler to the polymer network. The properties of the specimens can be influenced specifically via the vinyl content on the surface of the particles. Tensile strength, elasticity modulus, and Shore A hardness increase in line with the amount of vinyl groups on the SiO₂ surface.

### EXAMPLE 6

### Production of a Nanoparticle Powder

The nanoparticle dispersion in toluene from example 3.4 was freed from volatile constituents on a rotary evaporator under reduced pressure at 60° C. The granules obtained were ground to fine powder in a mortar, and were freed from volatile residues under reduced pressure at 60° C. for four hours. This gives a flowing white powder.
The powder can be redissolved quickly and without agglomeration in a variety of solvents. For this purpose, the powder is introduced into a glass vessel with a screw top lid, and nine times the amount by weight of the solvent in question are added. The material is then stirred with a magnetic stirrer for 15 minutes. The powder goes into solution without residue.
To investigate the dispersibility, the particle sizes before drying and after redispersion in solvent were compared.

TABLE 5

| | Particle | | | | | | | |
|---|---|---|---|---|---|---|---|---|
| | Original sol | | In toluene | | In BuAc | | In IPAc | |
| | D50 | | D50 | | D50 | | D50 | |
| | [nm] | Span | [nm] | Span | [nm] | Span | [nm] | Span |
| Example | 29 | 0.7 | 33 | 1.0 | 25 | 0.7 | 28 | 0.7 |
| 3.4 | | | | | | | | |

On account of the large surface area, the particles tend to form agglomerates when the solvent is removed. On redispersion, these agglomerates must be broken up again. The greater the match between the particle size distribution and the particle size distribution in the original sol, the more redispersible the particles.

Table 5 shows that the particles are readily redispersible in the solvents toluene, butyl acetate, and isopropyl acetate. In toluene, an insubstantially broadened particle size distribution is observed that is shifted to larger particle sizes. These changes, however, are within a range of the kind also observed on fluctuations from batch to batch. In isopropyl acetate the distribution measured is identical; in butyl acetate, it is shifted to somewhat smaller particle sizes, owing to solvent effects.

### EXAMPLE 7

### Production of a Methacrylate Filled with Nanoscale Particles

1050 g of silica sol (Levasil 200/40%, BET=200 m²/g, 40% SiO₂, Na⁺ removed with ion exchanger) were stirred with 62.58 g of gamma-methacryloxypropyltrimethoxysilane for 1 hour. The material was then diluted with 1250 g of THF, and, with stirring, 63 g of chlorotrimethylsilane were added. After an hour, two phases have formed. The top phase contained no solid and was discarded. The bottom phase was diluted with 150 g of THF, 63 g of chlorotrimethylsilane were added with stirring, and, after an hour, a further phase separation was carried out. The top phase was again discarded. The bottom phase was diluted with 400 g of toluene, and THF/water were distilled off with addition of further toluene.

The resulting toluene sol, which was still acidic, was heated under reflux, and the distillate flowing back was passed via a column filled with sodium carbonate. After six hours of reflux, the sol no longer gave an acidic reaction.

The toluene sol obtained was freed from volatile fractions under reduced pressure at 60° C. This gave a white powder.

By stirring with a magnetic stirrer, 50% dispersions of this powder in methyl methacrylate (MMA) can be produced which have a viscosity of only 18 mPas, are highly flowable, and are optically clear.

The pretreatment of the silica with gamma-methacryloxypropyltrimethoxysilane results in high compatibility with methacrylates such as MMA in relatively low dispersion times.

### EXAMPLE 8

### Production of an SiH Functionalized THF Sol

60 g of chlorotrimethylsilane were introduced in 1100 g of THF, and 926 g of silica sol (Levasil 200/40%, BET=200 m²/g, 40% SiO₂, Na⁺ removed with ion exchanger) were metered in over the course of 45 minutes. After an hour, two phases had formed, and were separated in a separating funnel. The 895.1 g bottom phase was reacted with 55 g of chloromethylsilane, with stirring. During the reaction, evolution of gas (hydrogen) was observed. Again, two phases were formed, which were separated in a separating funnel. The 729 g bottom phase was distilled out with a total of 400 g of toluene. The reaction mixture was heated under reflux over sodium carbonate until the condensate gave a neutral reaction.

The product contains 38.8% of solids. The SiH content is 0.4 mmol/g (determined by gas volumetry). After drying under reduced pressure, the resulting solid can be easily redispersed in toluene.

### EXAMPLE 9

### Hydrosilylation on the SiH Groups

50.4 g of 1-octene were introduced with 0.01 g of hexachloroplatinic acid and the mixture was heated to 90° C. Then, over the course of 10 minutes, 257 g of silica sol from example 8 were metered in and hydrosilylation took place at 100° C. for 1 hour. The SiH content went down to <0.007 mmol/g; i.e., in the reaction, the SiH groups on the surface of the particles were consumed completely by reaction with the 1-octene. This gave a clear, brown dispersion having a solids content of 33.6% and a particle size of 26 nm with a span of 0.6.

In the same way, the hydrosilylation was carried out successfully with styrene, undecylenic acid, allyl alcohol, allyl glycidyl ether, and allyl methacrylate.

1. A method of producing a nanoscale silicon dioxide, comprising the steps of:
a) providing an aqueous suspension of a colloidal silicon dioxide having an average particle size of 1 to 500 nm;
b) reacting it with an organosilane or organosiloxane in an aprotic cyclic ether, and silanizing the colloidal silicon dioxide;
c) separating the aqueous phase of the reaction mixture from the organic phase;
d) again reacting the organic phase with an organosilane or organosiloxane in an aprotic cyclic ether, and silanizing the colloidal silicon dioxide;
e) separating the aqueous phase of the reaction mixture from the organic phase.

2. The method of claim 1, wherein the colloidal silicon dioxide used in step a) has an average particle size of 2 to 300 nm.

3-23. (canceled)

24. The method of claim 1, wherein the colloidal silicon dioxide used in step a) has an average particle size of 3 to 200 nm.

25. The method of claim 1, wherein the colloidal silicon dioxide used in step a) has an average particle size of 4 to 150 nm.

26. The method of claim 1, wherein the colloidal silicon dioxide used in step a) has an average particle size of 4 to 80 nm.

27. The method of claim 1, wherein the colloidal silicon dioxide used in step a) has an average particle size of 10 to 40 nm.

28. The method of claim 1, wherein the nanoscale silicon dioxide is hydrophobic.

29. The method of claim 1, wherein the nanoscale silicon dioxide is composed to an extent of at least 50% of separate, unaggregated and unagglomerated primary particles.

30. The method of claim 1, wherein the nanoscale silicon dioxide is composed to an extent of at least 70% of separate, unaggregated and unagglomerated primary particles.

31. The method of claim 1, wherein the nanoscale silicon dioxide is composed to an extent of at least 80% of separate, unaggregated and unagglomerated primary particles.

32. The method of claim 1, wherein the nanoscale silicon dioxide is composed to an extent of at least 90% of separate, unaggregated and unagglomerated primary particles.

33. The method of claim 1, wherein the pH of the aqueous suspension of a colloidal silicon dioxide that is used in step a) is 5 or less.

34. The method of claim 1, wherein the pH of the aqueous suspension of a colloidal silicon dioxide that is used in step a) is 4 or less

35. The method of claim 1, wherein the aprotic cyclic ether is tetrahydrofuran (THF).

36. The method of claim 1, wherein the organosilanes or organosiloxanes are selected from the group consisting of organosilanes of the formula R¹ₐH_{b}SiX_{4-a-b} and organosiloxanes of the formula R¹ₙSiO_{(4-n)/2}, in which each R¹ independently is selected from hydrocarbon radicals having 1 to 18 carbon atoms or organofunctional hydrocarbon radicals having 1 to 18 carbon atoms, each X independently is selected from a halogen atom or alkoxy radicals having 1 to 18 carbon atoms, a=0, 1, 2 or 3, b=0 or 1, a+b=1, 2 or 3, with the proviso that if b=1, then a+b=2 or 3 and n is an integer from 2 up to and including 3.

37. The method of claim 1, wherein a halosilane is used.

38. The method of claim 37, wherein said halosilane is a chlorosilane.

39. The method of claim 1, wherein the silanization in steps b) and d) is carried out at 0 to 65° C.

40. The method of claim 1, wherein the silanization in steps b) and d) is carried out at 10 to 65° C.

41. The method of claim 1, wherein the first silanization in step b) is carried out at a lower temperature than the second silanization in step d).

42. The method of claim 1, wherein the aqueous suspension provided in step a) has an alkoxy silane added to it before step b) is carried out.

43. The method of claim 1, characterized by the further step of:
f) replacing the cyclic ether by another aprotic organic solvent.

44. The method of claim 43, wherein the cyclic ether is removed by distillation.

45. The method of claim 44, wherein the distillative removal of the cyclic ether is followed by heating under reflux.

45. The method of claim 45, wherein the refluxing solvent is neutralized with a base.

46. The method of claim 45, wherein neutralization takes place using a basic salt.

47. The method of claim 46, wherein the basic salt is an alkali metal or alkaline earth metal carbonate or hydrogen carbonate.

48. The method of claim 43, wherein the aprotic organic solvent is toluene.

49. The method of claim 1, wherein the silane or siloxane used in the second silanization step d) has free SiH groups, and so after the second silanization step there are free SiH groups on the surface of the silicon dioxide particles.

50. The method of claim 49, characterized by the further step of hydrosilylation on the SiH groups.

51. The method of claim 50, wherein the hydrosilylation is carried out with an alkene or an allyl compound.

52. The method of claim 1 or claim 43, comprising a further step of removing either the cyclic ether or another aprotic organic solvent that replaced it in a step f), such that the nanoscale silicon dioxide is provided in the form of a redispersible powder.

53. A redispersible nanoscale silicon dioxide powder obtainable by a method of claim 52.
